(19) United States
(12) Patent Application Publication
(10) Pub. No.: US 2021/0109608 A1
(43) Pub. Date: Apr. 15, 2021

(54) MOUSE AND HOUSING HAVING FLEXIBLE SURFACE

(71) Applicant: Teco Image Systems Co., Ltd., Taipei City (TW)

(72) Inventors: Ting-Chun Chen, Taipei City (TW); De-Bin Liu, Taipei City (TW)

(21) Appl. No.: 16/597,071

(22) Filed: Oct. 9, 2019

(51) Int. Cl. G06F 3/0354

(52) U.S. Cl. CPC G06F 3/03543

(57) ABSTRACT

A mouse includes a function body and a housing having a flexible surface. The housing having a flexible surface includes a main body and a flexible surface. The main body is connected with the function body. The main body has a frameset. The flexible surface has a plurality of polygon surfaces and a plurality of flexible connection portions. Each of the polygon surfaces is connected with an adjacent one of the polygon surfaces through at least one of the flexible connection portions. The flexible surface is disposed on the frameset, and the frameset is connected with the flexible surface through a part of the flexible connection portions. Therefore, the flexibility can be implemented, and the pressure of the biometric feature supported thereon can be uniformly distributed, thereby achieving the advantages of reducing the pressure.

### FIELD OF THE INVENTION

The present invention relates to a mouse, and more particularly to a mouse, which comprises a housing having a flexible surface.

### BACKGROUND OF THE INVENTION

A mouse is a popular input device of a computer in the modern society. Since many office works are accomplished through the mouse, the comfortability and functionality are highly related with the productivity.

In the conventional design of the mouse, a softer material is usually used as the area contacting with a palm of a user to reduce the surface hardness for reducing the pressure of the palm. Please refer to FIG. 1. FIG. 1 schematically illustrates a conventional mouse and the leather paint thereof. As shown in FIG. 1, in the prior art, a conventional mouse 1 is usually painted with the leather paint 12 on the upper cover 11 to reduce the surface hardness for reducing the pressure of the palm of the user.

However, a limitation of thickness is existed on the leather paint 12. Moreover, the leather paint itself has a specific hardness, so that it cannot be perfectly matched with the curve of the palm, and the pressure-reducing effectivity is so limited. Likewise, on many objects which have to be directly contacted with a biometric feature, the issue of poor pressure-reducing effectivity is existed.

Therefore, there is a need of providing a mouse and a housing having a flexible surface, which is appropriate to the biometric feature, and achieving well pressure-reducing effectivity distinct from the prior art in order to solve the above drawbacks.

### SUMMARY OF THE INVENTION

Some embodiments of the present invention are to provide a mouse and a housing having a flexible surface in order to overcome at least one of the above-mentioned drawbacks encountered by the prior arts.

The present invention provides a mouse and a housing having a flexible surface. Since the polygon surfaces of the flexible surface are connected by the flexible connection portions, each of the polygon surfaces is able to displace independently, so that the flexibility can be implemented, and the pressure of the biometric feature supported thereon can be uniformly distributed, thereby achieving the advantages of reducing the pressure.

In accordance with an aspect of the present invention, there is provided a mouse. The mouse includes a function body and a housing having a flexible surface. The housing having a flexible surface includes a main body and a flexible surface. The main body is connected with the function body. The main body has a frameset. The flexible surface has a plurality of polygon surfaces and a plurality of flexible connection portions. Each of the polygon surfaces is connected with an adjacent one of the polygon surfaces through at least one of the flexible connection portions. The flexible surface is disposed on the frameset, and the frameset is connected with the flexible surface through a part of the flexible connection portions.

In accordance with another aspect of the present invention, there is provided a housing having a flexible surface. The housing having a flexible surface includes a main body and a flexible surface. The main body has a frameset. The flexible surface has a plurality of polygon surfaces and a plurality of flexible connection portions. Each of the polygon surfaces is connected with an adjacent one of the polygon surfaces through at least one of the flexible connection portions. The flexible surface is disposed on the frameset, and the frameset is connected with the flexible surface through a part of the flexible connection portions.

The above contents of the present invention will become more readily apparent to those ordinarily skilled in the art after reviewing the following detailed description and accompanying drawings, in which:

### BRIEF DESCRIPTION OF THE DRAWINGS

FIG. 1 schematically illustrates a conventional mouse and the leather paint thereof;

FIG. 2 schematically illustrates the structure of a mouse according to an embodiment of the present invention;

FIG. 3 schematically illustrates the structure of a housing having a flexible surface according to an embodiment of the present invention;

FIG. 4 schematically illustrates a side view of the structure of the mouse shown in FIG. 2;

FIG. 5 schematically illustrates a partial structure of a housing having a flexible surface according to an embodiment of the present invention;

FIG. 6 schematically illustrates polygon surfaces of a housing having a flexible surface according to an embodiment of the present invention;

FIG. 7 schematically illustrates polygon surfaces of a housing having a flexible surface according to an embodiment of the present invention;

FIG. 8 schematically illustrates polygon surfaces of a housing having a flexible surface according to an embodiment of the present invention;

FIG. 9 schematically illustrates polygon surfaces and flexible connection portions of a flexible surface according to an embodiment of the present invention;

FIG. 10 schematically illustrates polygon surfaces and flexible connection portions of a flexible surface according to an embodiment of the present invention; and

FIG. 11 schematically illustrates the flexible surface of the present invention fitting a palm curve.

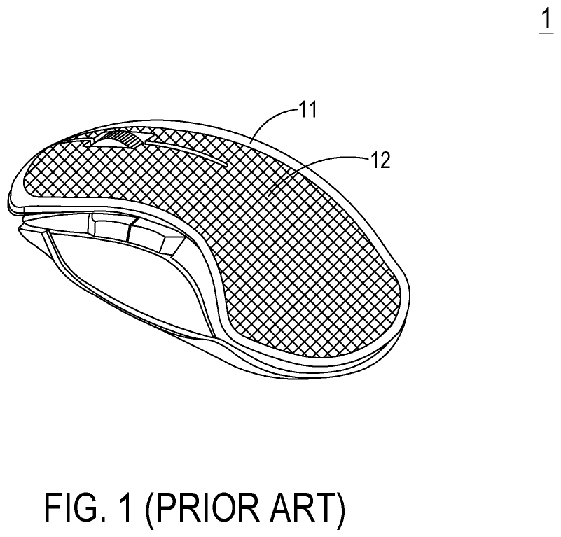

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

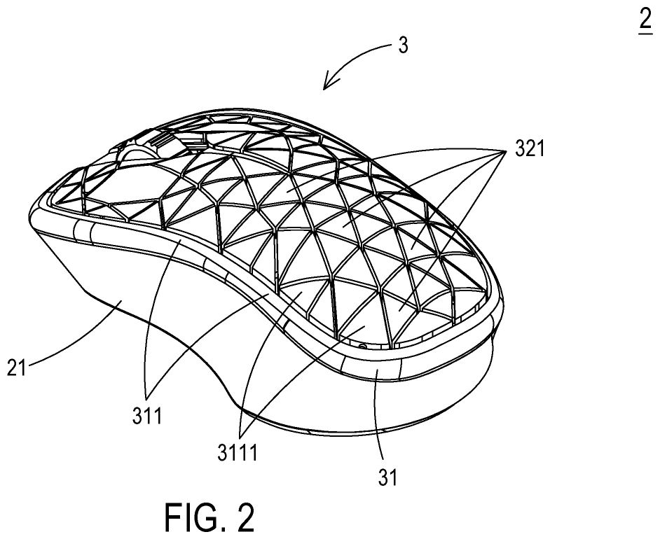

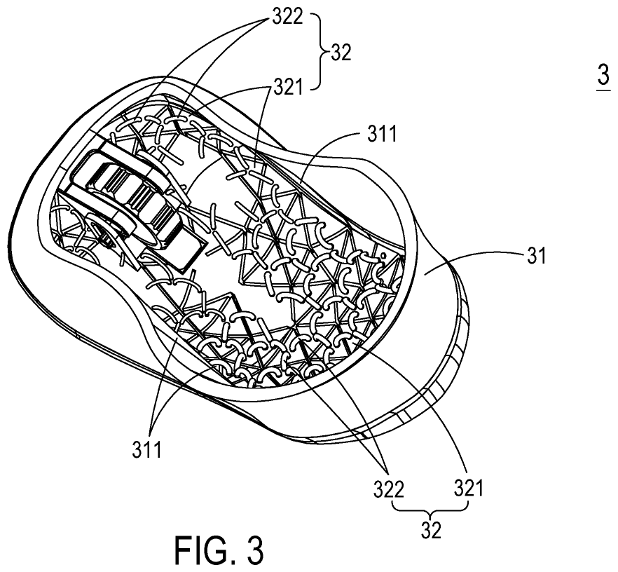

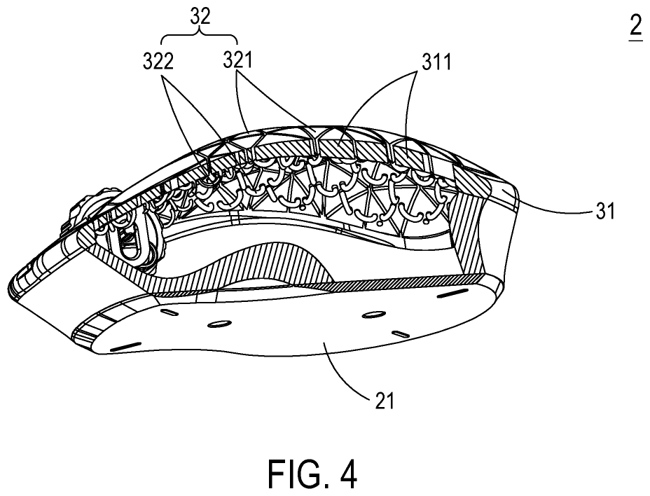

Please refer to FIG. 2, FIG. 3 and FIG. 4. FIG. 2 schematically illustrates the structure of a mouse according to an embodiment of the present invention. FIG. 3 schematically illustrates the structure of a housing having a flexible surface according to an embodiment of the present invention. FIG. 4 schematically illustrates a side view of the structure of the mouse shown in FIG. 2. As shown in FIGS. 2-4, according to an embodiment of the present invention, a mouse 2 of the present invention includes a function body 21 and a housing having a flexible surface 3. The housing having a flexible surface 3 includes a main body 31 and a flexible surface 32. The main body 31 is connected with the function body 21. The main body 31 has a frameset 311. The flexible surface 32 is preferably a flexible curved surface, but not limited thereto. The flexible surface 32 has a plurality of polygon surfaces 321 and a plurality of flexible connection portions 322. Each of the polygon surfaces 321 is connected with an adjacent one of the polygon surfaces 321 through at least one of the flexible connection portions 322. In other words, any two adjacent polygon surfaces 321 are connected by at least one of the flexible connection portions 322, but not limited thereto. In addition, the flexible surface 32 is disposed on the frameset 311, and the frameset 311 is connected with the flexible surface 32 through a part of the flexible connection portions 322. Therefore, each of the polygon surfaces 321 can displace independently and the flexibility can be implemented, so that the pressure of the biometric feature (e.g. a palm) supported thereon can be uniformly distributed, thereby achieving the advantages of reducing the pressure.

On the other hand, the main body 31 of the housing having a flexible surface 3 is not limited to be only connected with the function body 21 of the mouse 2. In some embodiments, the main body 31 and the frameset 311 thereof may match with another items, which has to be contacted with a biometric feature, by changing the exterior. For example, the main body 31 and the frameset 311 can be used as a part of a grip or a mat, but not limited thereto. The flexible surface 32 is preferably matched with the frameset 311. Moreover, the exteriors of the flexible surface 32 and the frameset 311 can be identical, but not limited thereto.

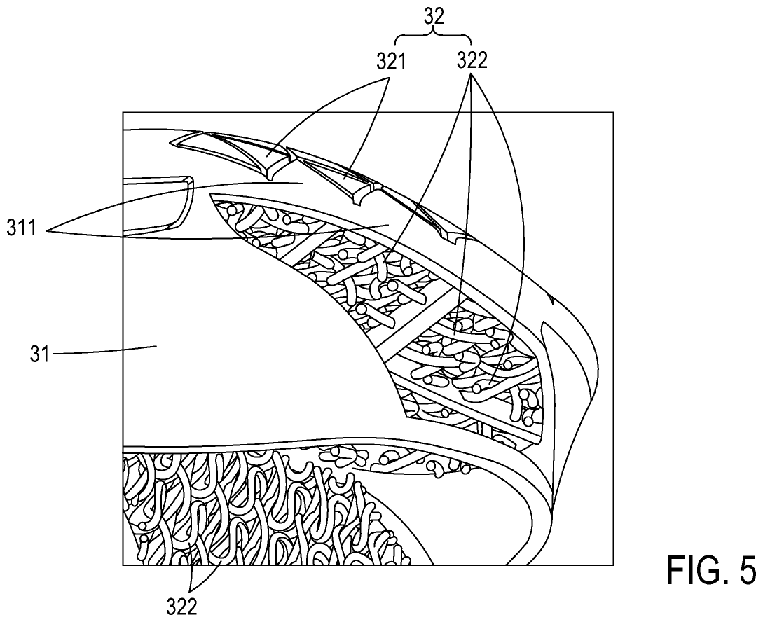

Please refer to FIG. 4 and FIG. 5. FIG. 5 schematically illustrates a partial structure of a housing having a flexible surface according to an embodiment of the present invention. In the plurality of the flexible connection portions 322 of the flexible surface 32 of the housing having a flexible surface 3, the flexible connection portions 322 each is a U-shaped flexible feature (as shown in FIG. 4), a flexible lattice structure (as shown in FIG. 5), or a flexible sponge (not shown), but not limited thereto. It should be noted that the flexible connection portion 322 can be selected according to the material of the main body 31 and/or the frameset 311 thereof, or according to the use of the item and the biometric feature to achieve proper effectivity of pressure-reducing.

In some embodiments, the housing having a flexible surface 3 and the main body 31 thereof, and the flexible surface 32 are preferably printed by a 3D printer, but not limited thereto. Moreover, the flexible connection portions 322 may also be made of flexible materials.

Please refer to FIGS. 2-4 again. In some embodiments, edge lengths of an edge of each of the polygon surfaces 321 and an edge of the adjacent one of the polygon surfaces 321 are equal. In addition, a gap is existed between an edge of each of the polygon surfaces 321 and an edge of the adjacent one of the polygon surfaces 321. In other words, a plurality of gaps are existed between the polygon surfaces. When a user grasps the mouse 2 of the present invention by palm, the flexible surface 32 is stressed by the palm, and the flexible surface 32 is forced at at least one force receiving point. Under this circumstance, the polygon surface 321 which is close to the force receiving point is moved downwardly. Since each polygon surface 321 is connected with another polygon surface 321 by the flexible connection portions 322, the adjacent polygon surfaces 321 will be moved accordingly. As a result, the gap is narrowed adjacent to the force receiving point, and the gap is enlarged away from the force receiving point.

Please refer to FIG. 2 again. In some embodiments, the frameset 311 of the main body 31 of the housing having a flexible surface 3 has a plurality of matching polygon surfaces 3111, and edge lengths of an edge of each of the matching polygon surfaces 3111 and an edge of at least one of the polygon surfaces 321 is equal. The edge of each of the matching polygon surfaces 3111 is connected with the edge of at least one of the polygon surfaces 321 through at least one of the flexible connection portions 322. In other words, the flexible surface 32 can be directly disposed on a frameset 311 having an opening or can be disposed on a frameset 311 having matching polygon surfaces 3111 on the edge thereof. The exterior of the matching polygon surfaces 3111 and the exterior of the polygon surfaces 321 of the flexible surface 32 are matched with each other or completely identical.

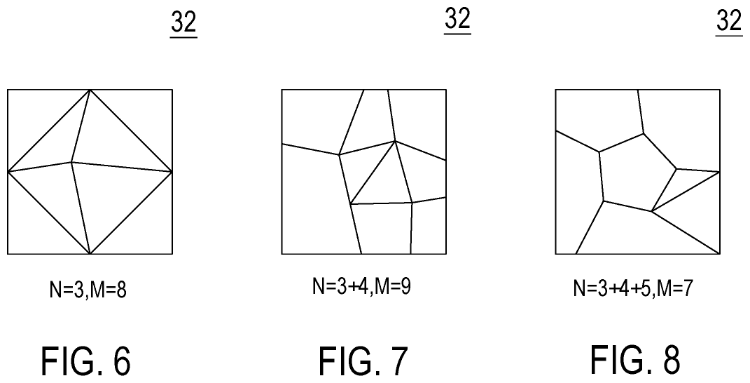

Please refer to FIGS. 6-8. FIG. 6 schematically illustrates polygon surfaces of a housing having a flexible surface according to an embodiment of the present invention. FIG. 7 schematically illustrates polygon surfaces of a housing having a flexible surface according to an embodiment of the present invention. FIG. 8 schematically illustrates polygon surfaces of a housing having a flexible surface according to an embodiment of the present invention. As shown in FIGS. 6-8, the polygon surfaces 321 each has N edges, and N is greater than or equal to 3. A total number of the polygon surfaces 321 is M, and M is a positive integer. For example, the values of N and M of the polygon surfaces 321 of the flexible surface 32 shown in FIG. 6 are respectively 3 and 8, the values of N and M of the polygon surfaces 321 of the flexible surface 32 shown in FIG. 7 are respectively 3+4 and 9, and the values of N and M of the polygon surfaces 321 of the flexible surface 32 shown in FIG. 8 are respectively 3+4+5 and 7. That is, when N and M is larger, the flexible surface 32 is divided in a finer way, and the flexible surface 32 is fitted a biometric feature more.

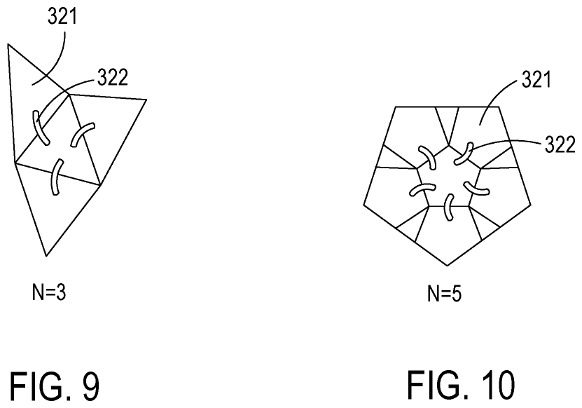

Please refer to FIG. 9 and FIG. 10. FIG. 9 schematically illustrates polygon surfaces and flexible connection portions of a flexible surface according to an embodiment of the present invention. FIG. 10 schematically illustrates polygon surfaces and flexible connection portions of a flexible surface according to an embodiment of the present invention. As shown in FIG. 9 and FIG. 10, when the flexible connection portions 322 of the flexible surface 32 are U-shaped flexible features, the flexible connection portions 322 are preferably connected to two polygon surfaces 321, which are able to relatively displace, and each flexible connection portion 322 crosses a gap.

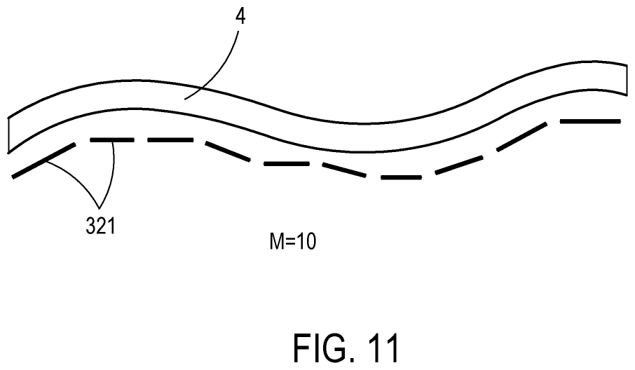

Furthermore, when a biometric feature (e.g. a palm of a human) is supported by the flexible surface 32 of the housing having a flexible surface 3, the flexible surface 32 may fit the curve of the biometric feature. Please refer to FIG. 11. FIG. 11 schematically illustrates the flexible surface of the present invention fitting a palm curve. As shown in FIG. 11, when the total number (i.e. the value M) of the polygon surfaces 321 is 10, it means that at least ten polygon surfaces 321 along a palm curve 4 are able to displace independently, such that the flexible surface 32 fits the palm curve 4.

From the above description, the present invention provides a mouse and a housing having a flexible surface. Since the polygon surfaces of the flexible surface are connected by the flexible connection portions, each of the polygon surfaces is able to displace independently, so that the flexibility can be implemented, and the pressure of the biometric feature supported thereon can be uniformly distributed, thereby achieving the advantages of reducing the pressure.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

1. A mouse, comprising:
a function body; and
a housing having a flexible surface, comprising:
a main body connected with the function body, wherein the main body has a frameset; and
a flexible surface having a plurality of polygon surfaces and a plurality of flexible connection portions, wherein each of the polygon surfaces is connected with an adjacent one of the polygon surfaces through at least one of the flexible connection positions, and each of the flexible connection portions is directly contacted with at least one of the polygon surfaces,
wherein the flexible surface is disposed on the frameset, and the frameset is connected with the flexible surface through a part of the flexible connection portions.

2. A housing having a flexible surface, comprising:
a main body having a frameset; and
a flexible surface having a plurality of polygon surfaces and a plurality of flexible connection portions, wherein each of the polygon surfaces is connected with an adjacent one of the polygon surfaces through at least one of the flexible connection portions, and each of the flexible connection portions is directly contacted with at least one of the polygon surfaces,
wherein the flexible surface is disposed on the frameset, and the frameset is connected with the flexible surface through a part of the flexible connection portions.

3. The housing having a flexible surface according to claim 2, wherein the polygon surfaces each has N edges, and N is greater than or equal to 3.

4. The housing having a flexible surface according to claim 3, wherein a total number of the polygon surfaces is M, and M is a positive integer.

5. (canceled)

6. The housing having a flexible surface according to claim 2, wherein edge lengths of an edge of each of the polygon surfaces and an edge of the adjacent one of the polygon surfaces are equal.

7. The housing having a flexible surface according to claim 2, wherein a gap is existed between an edge of each of the polygon surfaces and an edge of the adjacent one of the polygon surfaces.

8. The housing having a flexible surface according to claim 7, wherein when the flexible surface is forced at a force receiving point, the gap is narrowed adjacent to the force receiving point, and the gap is enlarged away from the force receiving point.

9. The housing having a flexible surface according to claim 2, wherein the frameset has a plurality of matching polygon surfaces, and edge lengths of an edge of each of the matching polygon surfaces and an edge of at least one of the polygon surfaces is equal, and wherein the edge of each of the matching polygon surfaces is connected with the edge of at least one of the polygon surfaces through at least one of the flexible connection portions.

10. The housing having a flexible surface according to claim 2, wherein the flexible connection portions each is a U-shaped flexible feature, a flexible lattice structure or a flexible sponge.
